(19) United States
(12) Patent Application Publication
(10) Pub. No.: US 2010/0182881 A1
(43) Pub. Date: Jul. 22, 2010

(54) RECORDING DEVICE, AND OPTICAL DISK SIGNAL PROCESSING METHOD

(76) Inventors: Masato Asano, Osaka (JP); Kyogo Masaki, Hyogo (JP); Yasuaki Murakawa, Kyotoq (JP)

Correspondence Address: MCDERMOTT WILL & EMERY LLP, 600 13TH STREET, NW, WASHINGTON, DC, 20005-3096, US

(21) Appl. No.: 12/667,025

(22) PCT Filed: May 16, 2008
(86) PCT No.: PCT/JP2008/001234

§ 371 Date: Dec. 28, 2009

(30) Foreign Application Priority Data
Jun. 28, 2007 (JP) 2007-170615

(51) Int. Cl. G11B 7/00

(52) U.S. Cl. 369/44.35; G9B/7

(57) ABSTRACT

An optical disk signal processing unit (200) performs tracking control to control a position of a converging lens (103) of an optical pickup (100) based on a tracking error signal, and a track jump operation to move the converging lens (103) of the optical pickup (100) in a radial direction of an optical disk (500) while the tracking control is stopped. A gain-increase computation section (209) obtains an amount of increase in a loop gain of a tracking control system based on a velocity of eccentricity of the optical disk (500) at the time of the track jump. After the track jump operation, the tracking control is performed in a situation where the loop gain of the tracking control system has been increased by the amount of increase obtained by the gain-increase computation section (209).

### TECHNICAL FIELD

The present invention relates to optical disk signal processing units, optical disk data reproducing and recording devices, and optical disk signal processing methods. More particularly, the present invention relates to optical disk signal processing units, optical disk data reproducing and recording devices, and optical disk signal processing methods which perform tracking control.

### BACKGROUND ART

In Patent Document 1, a track-jump control method used in conventional optical disks is described. This track jump control method performs a track jump operation to a target track on an optical disk in a situation where a tracking servo circuit is in an OFF state; and when an irradiated point of a laser light reaches the target track, the method turns on the tracking servo circuit, and increases a gain of the tracking servo circuit from a steady-state gain.

In addition, after increasing the gain of the tracking servo circuit from the steady-state gain, this track-jump control method detects whether the level of a tracking error signal is within a predetermined range or not, and, if the level is within the predetermined range, returns the gain to the steady-state gain.

### CITATION LIST

### Patent Document

PATENT DOCUMENT 1: Japanese Unexamined Patent Application Publication

### SUMMARY OF INVENTION

### Technical Problem

However, it has been found that if the conventional track-jump control method mentioned above is used, the settling time of a tracking control after a track jump is long depending on the increase in a gain of the tracking servo circuit after the track jump. Then, as a result, an access time of an optical disk device is lengthened, and the user-friendliness is reduced.

In addition, in order to determine a timing to return the gain to a steady-state gain, an optical disk device needs to have a function for detecting whether the level of the tracking error signal is within a predetermined range or not. As such, the cost of an optical disk device becomes high.

In view of the foregoing, it is an object of the present invention to shorten the access time of an optical disk device, and to reduce the cost of an optical disk device.

### Solution to Problem

In order to solve the above problems, the present invention is directed to optical disk signal processing which performs, in an optical disk device, tracking control to control a position of an optical pickup based on a tracking error signal, and a track jump operation to move the optical pickup in a radial direction of an optical disk while the tracking control is stopped, and the optical disk signal processing is characterized by

obtaining an amount of change of a loop gain of a tracking control system based on a velocity of eccentricity of the optical disk at the time of the track jump operation, and

performing the tracking control after the track jump operation in a situation where the loop gain of the tracking control system has been changed by the amount of change obtained.

It is assumed that there is a correlation between the velocity of eccentricity at the time of the track jump operation and the tracking error after the track jump operation. Therefore, by changing after the track jump operation the loop gain of the tracking control system by the amount of change depending on the velocity of eccentricity, it is possible to shorten the settling time of the tracking control, and to reduce the access time of the optical disk device.

In addition, the present invention is directed to

optical disk signal processing which performs, in an optical disk device, tracking control to control a position of an optical pickup based on a tracking error signal, and a track jump operation to move the optical pickup in a radial direction of an optical disk while the tracking control is stopped, and the optical disk signal processing is characterized by

performing the tracking control in a situation where the loop gain of the tracking control system is changed from the loop gain before the track jump operation for a particular time period after the track jump operation, and returning after the particular time period has elapsed, the loop gain of the tracking control system to the loop gain before the track jump operation.

Accordingly, a tracking control is performed for a particular time period after the track jump operation in a situation where the loop gain of the tracking control system has been changed from the loop gain before the track jump operation, and thereafter, the loop gain of the tracking control system returns to the loop gain before the track jump. Therefore, since a function is not required to be provided to detect whether the level of the tracking error signal is within a predetermined range or not in order to determine a timing to return the gain to the steady-state gain, the cost of an optical disk device can be reduced.

Here, “to move the optical pickup” means not only to move the entire optical pickup, but also to move a part of the optical pickup.

### Advantages of Invention

According to the present invention, after a track-jump control signal is output by a jump pulse output section, the loop gain of the tracking control system changes by an amount of change depending on the velocity of eccentricity. Therefore, it is possible to shorten a settling time of a tracking control, and to reduce the access time of an optical disk device.

In addition, since a function is not required to be provided in an optical disk device to detect whether the level of the tracking error signal is within a predetermined range or not in order to determine a timing to return the gain to the steady-state gain, the cost of an optical disk device can be reduced.

### BRIEF DESCRIPTION OF DRAWINGS

FIG. 1 is a block diagram illustrating a configuration of an optical disk data reproducing and recording device in accordance with an embodiment.

FIG. 2 is a block diagram illustrating a configuration of the optical pickup 100 in accordance with the same.

FIG. 3 is a block diagram illustrating a configuration of the tracking control section 202 in accordance with the same.

FIG. 4 is an illustration showing an example of an optical disk having an eccentricity in accordance with the same.

FIG. 5 depicts illustrations showing a variation in a radial location of a light beam when the light beam was emitted to an optical disk having an eccentricity, in accordance with the same.

FIG. 6 depicts waveform charts illustrating a variation in the radial location of the light beam and a variation in a low-frequency component of a tracking error signal, in accordance with the same.

FIG. 7 is a block diagram illustrating a configuration of the eccentricity-amount derivation section 207 in accordance with the same.

FIG. 8 depicts graphs illustrating a relationship between an amount of eccentricity and a velocity of eccentricity in accordance with the same.

FIG. 9 is an illustration showing a process to obtain a corrective gain by the gain-increase computation section 209 in accordance with the same.

FIG. 10 is a graph illustrating a relationship between the corrective gain and the velocity of eccentricity in accordance with the same.

FIG. 11 is a table showing an example of the corrective gain which is obtained based on the threshold E₀′(t) and the velocity of eccentricity E₁′(t) in accordance with the same.

FIG. 12 is a graph illustrating a relationship between the corrective gain and the velocity of eccentricity in a case where an amplitude-limiting operation function is provided in the gain-increase computation section 209.

FIG. 13 is a graph illustrating open-loop characteristics of the tracking control system before the track jump and immediately after the track jump, in accordance with the same.

FIG. 14 is a flowchart illustrating the operations of respective sections of the optical disk data reproducing and recording device in accordance with the same.

FIG. 15 is an illustration showing a groove 301 of an optical disk and a spot 302 of a light beam in accordance with the same.

FIG. 16 is a flowchart illustrating the operations of respective sections of the optical disk data reproducing and recording device in accordance with the same.

FIG. 17 is a graph illustrating waveforms of various signals when a track jump is executed, and a state of the optical disk data reproducing and recording device, etc., in accordance with the same.

FIG. 18 is a graph illustrating waveforms of various signals in a case where the loop gain is constant, in accordance with the same.

FIG. 19 is a graph illustrating waveforms of various signals in a case where the loop gain is increased by a factor of 1.5 after the track jump, in accordance with the same.

FIG. 20 is a graph illustrating a relationship between the corrective gain and the velocity of eccentricity in a variation of the embodiment.

FIG. 21 is a graph illustrating a relationship between the corrective gain and the velocity of eccentricity in another variation of the embodiment.

FIG. 22 is a graph illustrating a relationship between the corrective gain and the velocity of eccentricity in a still another variation of the embodiment.

### DESCRIPTION OF EMBODIMENTS

An embodiment of the present invention will be described below in detail with reference to the drawings.

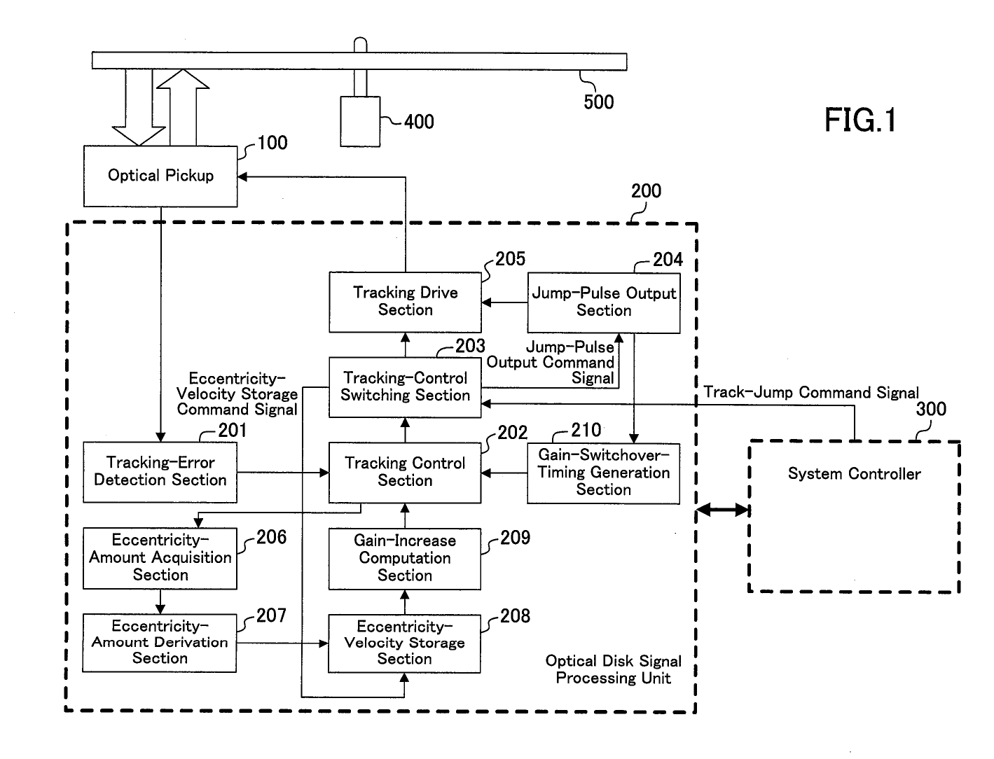

An optical disk data reproducing and recording device in accordance with an embodiment of the present invention includes, as shown in FIG. 1, an optical pickup 100, an optical disk signal processing unit 200, a system controller 300, and a rotational part 400, and performs reproduction and recording of data on an optical disk (a recording media) 500. When a track jump is performed, that is, when an irradiated point of a light beam emitted from the optical pickup 100 to the optical disk 500 is moved from the center of a groove existing on the optical disk 500 or the center of a pit on the optical disk 500 in a radial direction, the optical disk signal processing unit 200 controls the optical pickup 100 so that the light beam will converge onto the center of a groove or the center of a pit existing at a target location of the movement. The rotational part 400 rotates the optical disk 500.

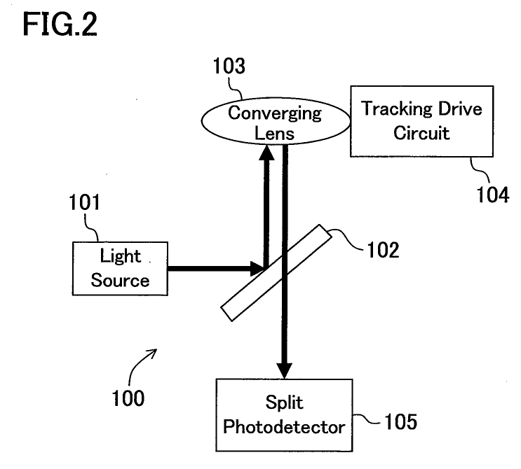

As shown in FIG. 2, the optical pickup 100 includes a light source 101, a semi-transparent mirror 102, a converging lens 103, a tracking drive circuit 104 having an actuator, etc., and a split photodetector 105. The split photodetector 105 outputs a signal which represents a physical distance between an irradiated point of a light beam and a target irradiated point of the light beam on the optical disk 500. The tracking drive circuit 104 moves the converging lens 103 according to a drive signal which is output by a tracking drive section 205 of the optical disk signal processing unit 200. Here, the target irradiated point of the light beam is the center of a groove existing on the optical disk 500 or the center of a pit existing on the optical disk 500.

The optical disk signal processing unit 200 includes a tracking-error detection section 201, a tracking control section 202, a tracking-control switching section 203, a jump-pulse output section 204, a tracking drive section 205, an eccentricity-amount acquisition section 206, an eccentricity-amount derivation section 207, an eccentricity-velocity storage section 208, a gain-increase computation section 209, and a gain-switchover-timing generation section 210. The functions of the optical disk signal processing unit 200 can be implemented by a DSP (Digital Signal Processor).

The tracking-error detection section 201 receives a signal which is output by the optical pickup 100, and outputs a tracking error signal which represents an amount of movement (a tracking error) from the location of a reflected beam when a light beam is focused on a target irradiated point of the light beam on the optical disk 500 to the actual location of a reflected beam. This tracking error signal represents a physical distance in a radial direction between the target irradiated point of the light beam on the optical disk 500 and the actual irradiated point of the light beam.

The tracking control section 202 obtains an amount of movement of the converging lens 103 for reducing the physical distance in a radial direction (a tracking error) between the target irradiated point of the light beam and the actual irradiated point of the light beam based on the tracking error signal which is output by the tracking-error detection section 201, and outputs a tracking control signal representing the amount of movement obtained to the tracking drive section 205. The tracking control section 202 controls the tracking drive section 205 by means of this tracking control signal.

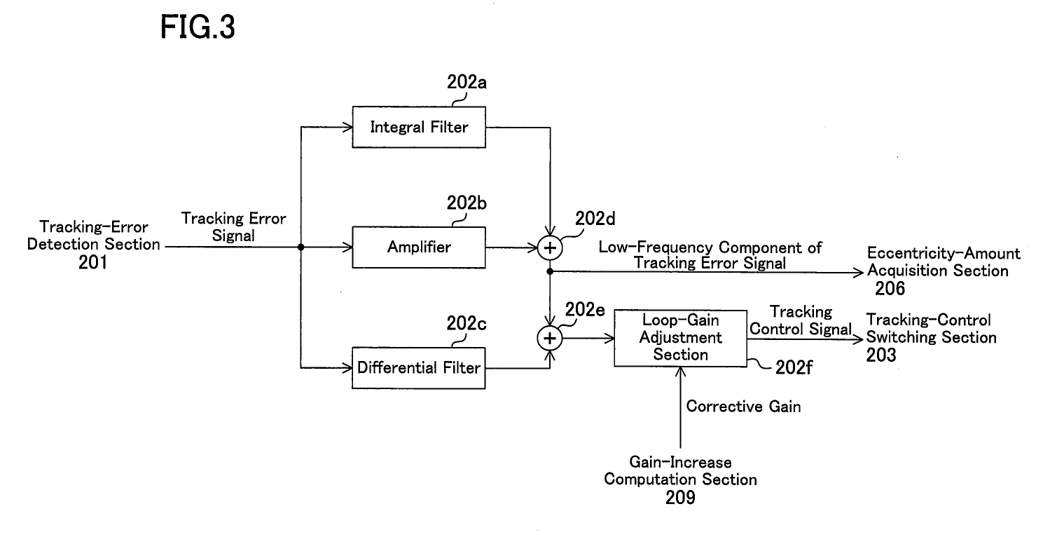

In more detail, as shown in FIG. 3, the tracking control section 202 includes an integral filter 202a, an amplifier 202b, a differential filter 202c, an adder 202d, an adder 202e, and a loop-gain adjustment section 202f. The loop-gain adjustment section 202f changes a loop gain of the tracking control system to a value which is obtained by multiplying the previous loop gain by a corrective gain which is output by the gain-increase computation section 209, which will be described below, after a track-jump control signal is output from the jump-pulse output section 204. More specifically, the loop-gain adjustment section 202f includes an amplifier which receives an output of the adder 202e, and multiplies the gain of the amplifier by the corrective gain after the track-jump control signal is output from the jump-pulse output section 204.

The tracking-control switching section 203 can be switched between a state of transmitting the tracking control signal output by the tracking control section 202 to the tracking drive section 205, and a state of not transmitting this signal to the tracking drive section 205, by using a track-jump command signal which is input from the system controller 300. In more detail, when no track jump is being performed, transmission of a tracking control signal from the tracking control section 202 to the tracking drive section 205 is performed, at the time of a track jump, the transmission is stopped. A track jump command signal is a signal to instruct the optical disk signal processing unit 200 to execute a track jump. Also, the tracking-control switching section 203 outputs a jump-pulse output command signal and an eccentricity-velocity storage command signal in response to the track-jump command signal. A jump-pulse output command signal is a signal to instruct the jump-pulse output section 204, which will be described below, to start outputting the track jump control signal; and an eccentricity-velocity storage command signal is a signal to instruct the eccentricity-velocity storage section 208, which will be described below, to store the velocity of eccentricity in a memory. When the tracking-control switching section 203 receives a track-jump command signal, it instructs the eccentricity-velocity storage section 208 to store the velocity of eccentricity by outputting an eccentricity-velocity storage command signal before stopping the transmission of a tracking control signal, and instructs the jump-pulse output section 204 to start outputting a track jump control signal by outputting a jump-pulse output command signal after stopping the transmission of the tracking control signal.

The jump-pulse output section 204 outputs to the tracking drive section 205 a track-jump control signal which represents an amount of movement of the converging lens 103 for a track jump in response to a jump-pulse output command signal, which is output by the tracking-control switching section 203.

The tracking drive section 205 receives the tracking control signal transmitted by the tracking-control switching section 203, performs operations such as D/A conversion, and outputs to the tracking drive circuit 104 of the optical pickup 100 a drive signal to move the converging lens 103 by an amount of movement represented by the tracking control signal. Also, at the time of a track jump, the tracking drive section 205 receives the track-jump control signal which is output from the jump-pulse output section 204, performs operations such as D/A conversion, and outputs to the tracking drive circuit 104 of the optical pickup 100 a drive signal to move the converging lens 103 in a radial direction of the optical disk 500 by an amount of movement represented by the track jump control signal.

The eccentricity-amount acquisition section 206 acquires a variation in a low-frequency component of the tracking error signal which is output by the tracking-error detection section 201 as a change in the amount of eccentricity, and outputs this change to the eccentricity-amount derivation section 207. More specifically, the eccentricity-amount acquisition section 206 obtains an output of the adder 202d in the tracking control section 202, and outputs this output to the eccentricity-amount derivation section 207. Note that when the low-frequency component of the tracking error signal is a small signal, the voltage level may be multiplied by a predetermined factor, and then be output to the eccentricity-amount derivation section 207.

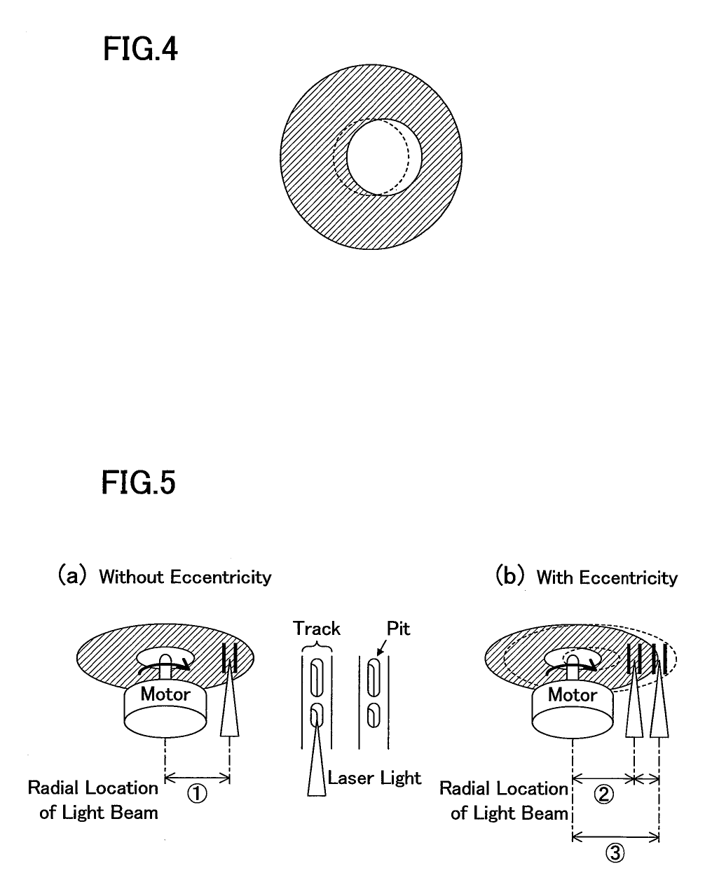

FIG. 4 is an illustration showing an example of an optical disk having an eccentricity. As shown in this figure, in an optical disk having an eccentricity, the center point of the rotation of the optical disk is out of alignment with respect to the center point of the optical disk itself.

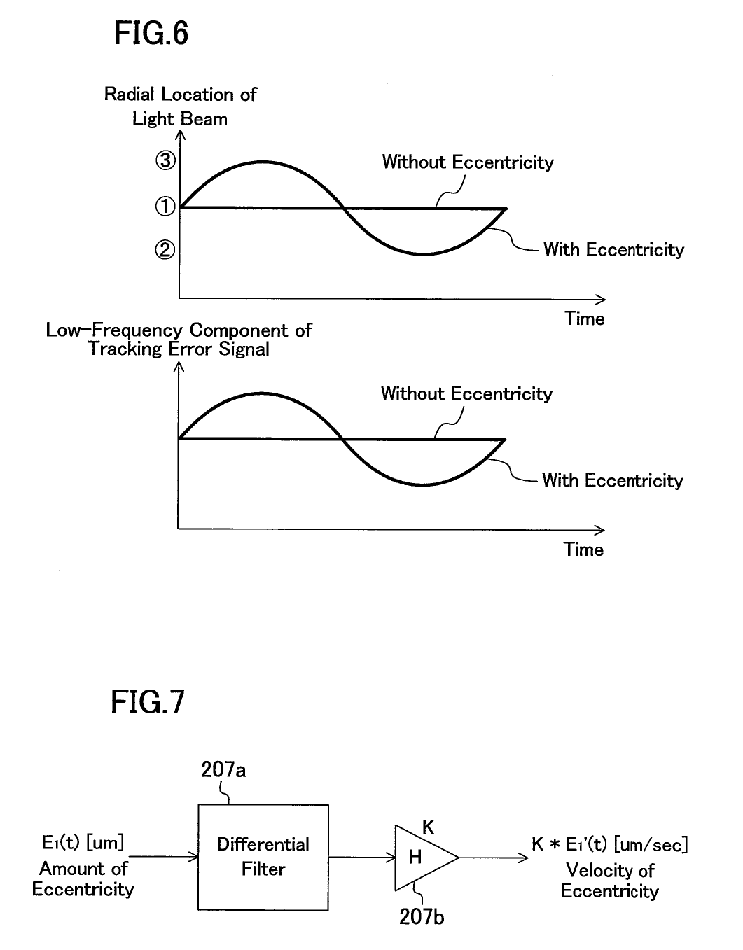

If the optical disk does not have an eccentricity, as shown in FIG. 5(a), for example, the distance from the center point of the rotation of the optical disk to the irradiated point of the light beam is nearly constant while the light beam is emitted along one circuit of a track. On the other hand, if the optical disk has an eccentricity, as shown in FIG. 5(b), for example, the distance from the center point of the rotation of the optical disk to the irradiated point of the light beam varies depending on the point on the optical disk to which the light beam is emitted while the light beam is emitted along one circuit of a track. In more detail, when the light beam is focused on the center of a groove of the optical disk having an eccentricity, the radial location of the light beam (the distance from the center point of the rotation of the optical disk to the irradiated point of the light beam) varies in synchronization with the rotation of the optical disk as shown in FIG. 6. As shown in this figure, the waveform representing the variation in the radial location of the light beam and the waveform representing the variation in the low-frequency component of the tracking error signal are similar. Therefore, it can be assumed that the variation in the low-frequency component of the tracking error signal represents the variation in the distance from the center point of the rotation of the optical disk to the irradiated point of the light beam.

The eccentricity-amount derivation section 207 differentiates the variation in the low-frequency component of the tracking error signal (the change in the amount of eccentricity) acquired by the eccentricity-amount acquisition section 206, and outputs a derivation result. The derivation result represents a temporal change rate of the distance from the center point of the rotation of the optical disk to the irradiated point of the light beam, that is, a temporal change rate of the amount of eccentricity. This derivation result representing a temporal change rate of the amount of eccentricity is referred to as a velocity of eccentricity.

As a specific configuration, the eccentricity-amount derivation section 207 includes, as shown in FIG. 7, a differential filter 207a and an attenuator 207b which adjusts the detection sensitivity for a velocity of eccentricity.

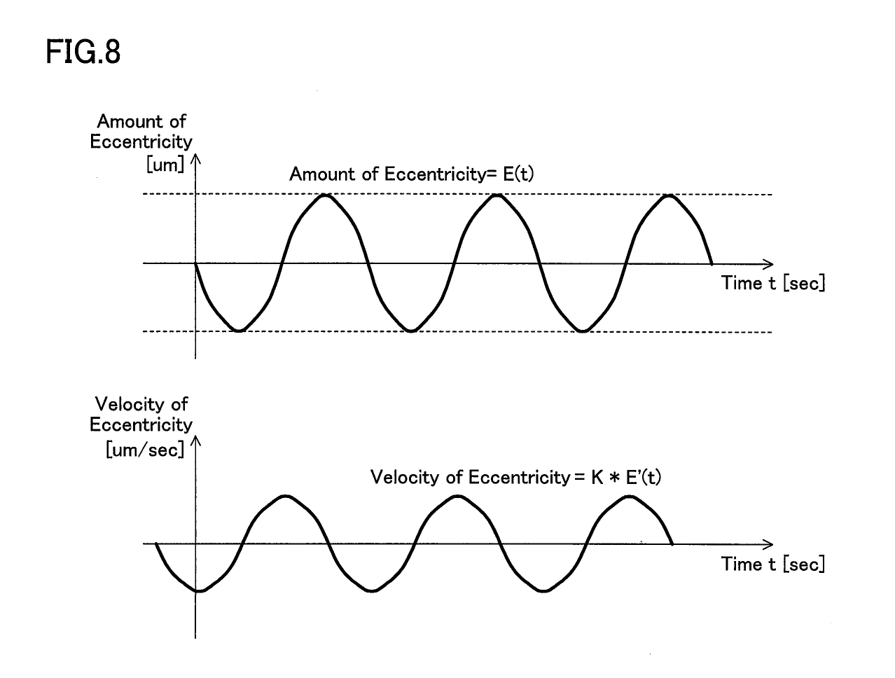

A relationship between an amount of eccentricity and a velocity of eccentricity is, for example, as shown in FIG. 8.

The eccentricity-velocity storage section 208 stores, in the memory, the velocity of eccentricity E₁′(t), which is output (computed) by the eccentricity-amount derivation section 207 immediately before the track jump control signal is output by the jump-pulse output section 204. In more detail, the eccentricity-velocity storage section 208 stores the velocity of eccentricity E₁′(t) in the memory in response to the eccentricity-velocity storage command signal which is output by the tracking-control switching section 203.

The gain-increase computation section (gain-change computation section) 209 obtains a corrective gain which indicates how many times the loop gain of the tracking control system after the track jump is made as large as the loop gain of the tracking control system before the track jump (the amount of change in the loop gain) based on the velocity of eccentricity stored in the memory by the eccentricity-velocity storage section 208.

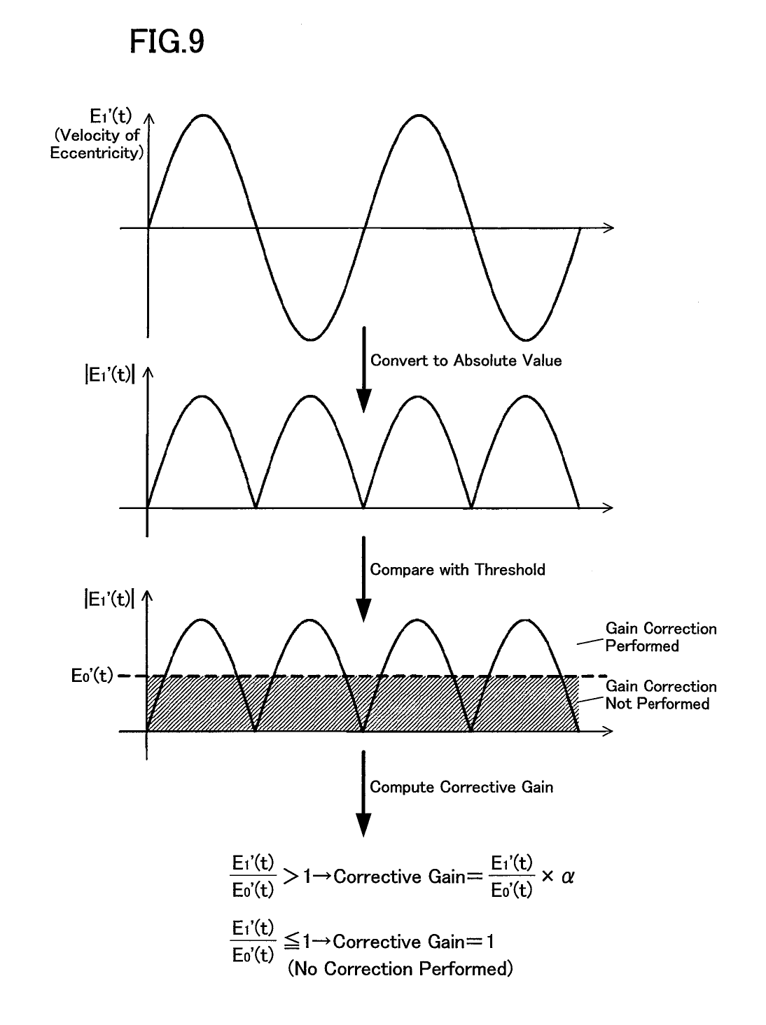

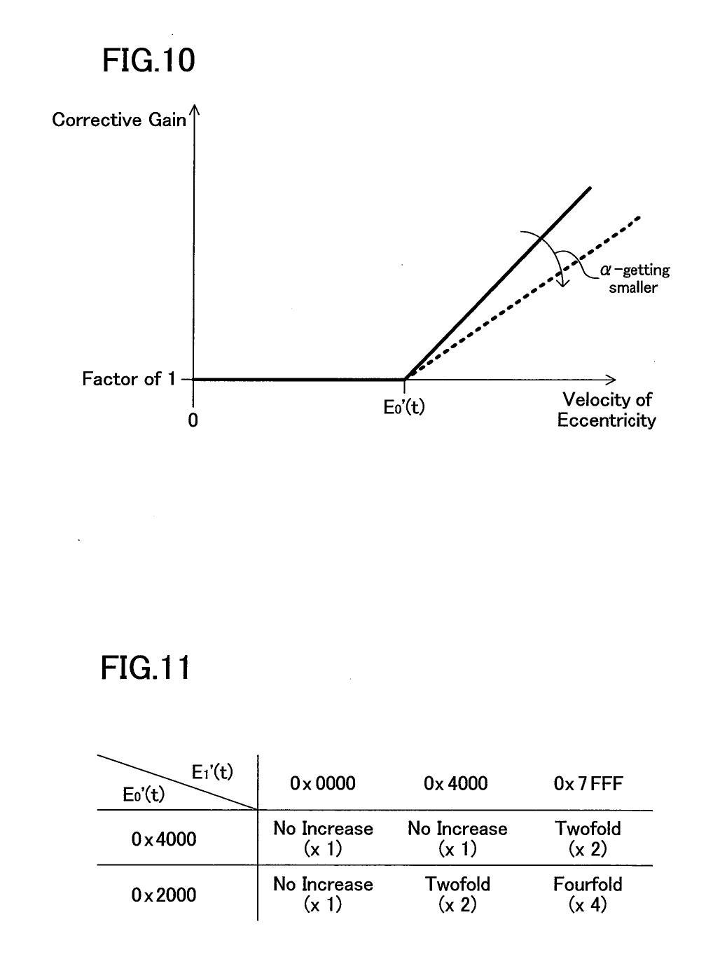

The gain-increase computation section 209, as shown in FIG. 9, compares the absolute value of the velocity of eccentricity E₁′(t) stored in the memory with a threshold E₀′(t), and outputs (E₁′(t)/E₀′(t)×α as the corrective gain when the absolute value of the velocity of eccentricity E₁′(t) is greater than the threshold E₀′(t), and outputs 1 as the corrective gain when the absolute value of the velocity of eccentricity E₁′(t) is less than or equal to the threshold E₀′(t). FIG. 10 is a graph illustrating a relationship between the corrective gain and the velocity of eccentricity. The corrective gain is 1 when the absolute value of the velocity of eccentricity E₁′(t) is within a range from 0 to the threshold E₀′(t), and increases in proportion to an increase in the velocity of eccentricity when the absolute value of the velocity of eccentricity E₁′(t) exceeds the threshold E₀′(t). In other words, the increase in the loop gain is 0 when the absolute value of the velocity of eccentricity E₁′(t) is less than or equal to the threshold E₀′(t), and increases in proportion to the increase in the velocity of eccentricity when the absolute value of the velocity of eccentricity E₁′(t) is greater than the threshold E₀′(t). FIG. 11 is a table showing an example of the corrective gain which is obtained based on the threshold E₀′(t) and the velocity of eccentricity E₁′(t).

Since the velocity of eccentricity is dependent on the amount of eccentricity of the optical disk 500 having an eccentricity and the rotation speed of the optical disk 500, the gain-increase computation section 209 treats the corrective gain for the loop gain as dependent on the amount of eccentricity of the optical disk 500 and the rotation speed of the optical disk 500.

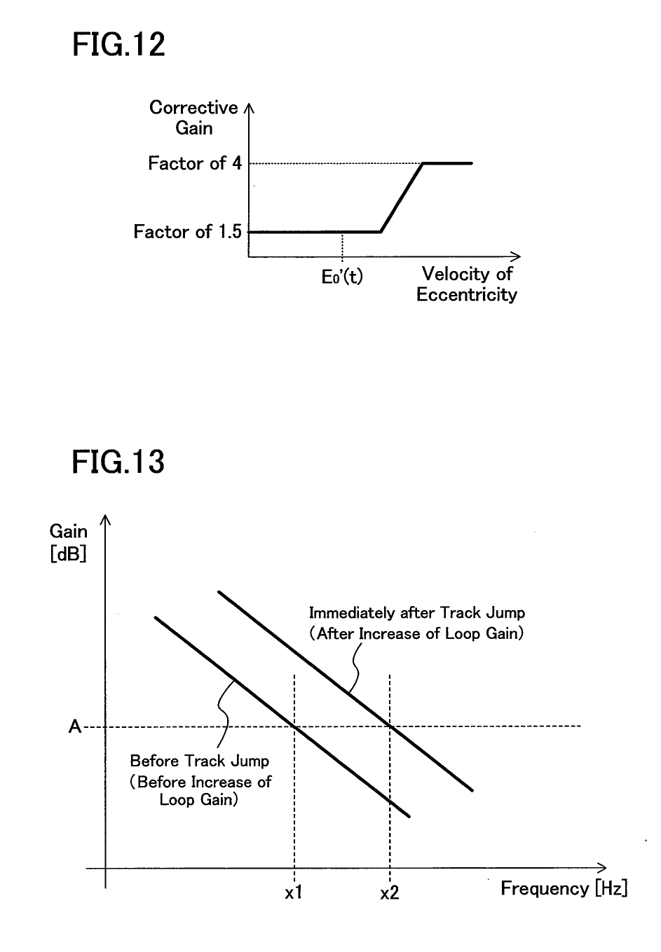

Note that in cases where the range of the corrective gain is desired to fall within a range from the factor of 1.5 to the factor of four, but a computation result by the gain-increase computation section 209 does not fall within this range, the gain-increase computation section 209 may be provided with an amplitude-limiting operation function which performs clipping (limiting) of the corrective gain at the factor of 1.5 or the factor of four. FIG. 12 shows a graph illustrating a relationship of the corrective gain which is output from the gain-increase computation section 209 and the velocity of eccentricity in a case where the corrective gain is clipped at the factor of 1.5 and the factor of four. Note that it is desirable to place an upper limit of the corrective gain on the factor of approximately four.

The gain-switchover-timing generation section 210 outputs to the tracking control section 202 a timing signal indicating a timing to switch from the loop gain obtained by multiplication by the corrective gain to the loop gain before being multiplied by the corrective gain. After a track-jump control signal is output from the jump-pulse output section 204, the loop gain of the tracking control system is multiplied by the corrective gain by the loop-gain adjustment section 202f of the tracking control section 202. Thereafter, at a rising edge of this timing signal which is output by the gain-switchover-timing generation section 210, the loop-gain adjustment section 202f of the tracking control section 202 returns the loop gain of the tracking control system to the loop gain before being multiplied by the corrective gain.

Note that the loop gain is maintained at a value obtained by multiplication by the corrective gain for a particular time period after the track-jump control signal is output from the jump-pulse output section 204. It is preferred that this particular time period be a time period corresponding to the reciprocal of the frequency x2 (1/x2) of a disturbance in a case where a gain of an open-loop characteristic of the tracking control system is 0 dB (A dB). This disturbance is a disturbance imposed to a tracking error signal. In cases where the gain of the open-loop characteristic is a factor of P, when a disturbance corresponding to a displacement Q [μm] in a radial direction from a target position of the converging lens to an actual position is imposed to the tracking error signal, the displacement in a radial direction from the target position of the converging lens to the actual position is less than or equal to Q/P [μm]. The frequency of a disturbance when the gain of the open-loop characteristic of the tracking control system is a factor of P can be obtained, for example, by performing an operation to impose a disturbance corresponding to the displacement Q [μm] to the tracking error signal for each disturbance of a plurality of frequencies, and by identifying the frequency when the displacement in a radial direction from a target position of the converging lens to an actual position is Q/P [μm] at a maximum.

In this embodiment, an open-loop characteristic of the tracking control system immediately after a track jump is represented by the Bode diagram shown in FIG. 13, and the gain crossover point of this Bode diagram is 5 kHz. That is, A=0 dB, and x2=5 kHz. Then, the time period for maintaining the loop gain at a value obtained by multiplication by the corrective gain is obtained as 1/5 kHz=200 μsec. Therefore, the gain-switchover-timing generation section 210 is configured to generate a timing signal which rises 200 μsec after the completion of outputting the track jump control signal by the jump-pulse output section 204.

Next, an operation of the optical disk data reproducing and recording device configured as above will be described below.

Focus control to focus a light beam onto the optical disk 500 will now be described. First, a light beam from the light source 101 enters the converging lens 103 which is out of alignment with respect to the optical axis; the light beam passed through the converging lens 103 is emitted onto the optical disk 500; and the semi-transparent mirror 102 separates its reflected beam which is from the optical disk 500 and directs the light to the split photodetector 105. In this situation, since the light beam from the light source 101 is incident on the converging lens 103 which is out of alignment with respect to the optical axis, the location of the reflected beam moves according to upward and downward movement of the optical disk 500. The split photodetector 105 detects this movement of the reflected beam, and outputs a focusing error signal representing an amount of movement of the reflected beam with respect to the location when focus is on the converging lens 103. Then, a control section not shown obtains an amount of movement of the converging lens 103 for reducing the amount of movement represented by the focusing error signal, and outputs a drive signal to move the converging lens 103 by the amount of movement obtained.

With the above-mentioned control being continuously performed, a focus-control ON state in which the light beam is focused on the converging lens 103 is maintained.

Next, tracking control to focus the light beam onto the center of a groove existing on the optical disk 500 will be described. First, the split photodetector 105 detects a physical distance between the light beam and the center of a groove existing on the optical disk 500. Then, the tracking-error detection section 201 outputs a tracking error signal representing an amount of movement (a tracking error) from the location of the reflected beam when focus is on the center of a groove existing on the optical disk 500 to the actual location of the reflected beam. Next, the tracking control section 202 obtains the amount of movement of the converging lens 103 for reducing the tracking error based on the tracking error signal which is output by the tracking-error detection section 201, and outputs a tracking control signal representing the amount of movement obtained. Furthermore, the tracking drive section 205 outputs to the tracking drive circuit 104 a drive signal to move the converging lens 103 by the amount of movement represented by the tracking control signal which is output by the tracking control section 202. The tracking drive circuit 104 moves the converging lens 103 by means of this drive signal. Thus, the optical disk signal processing unit 200 controls the position of the converging lens 103 of the optical pickup 100 by means of the drive signal obtained based on the tracking error signal.

With the above-mentioned control being continuously performed, a tracking-control ON state in which the light beam is focused on the center of a groove existing on the optical disk 500 is maintained.

Next, operations of various sections for track jump control will be described below.

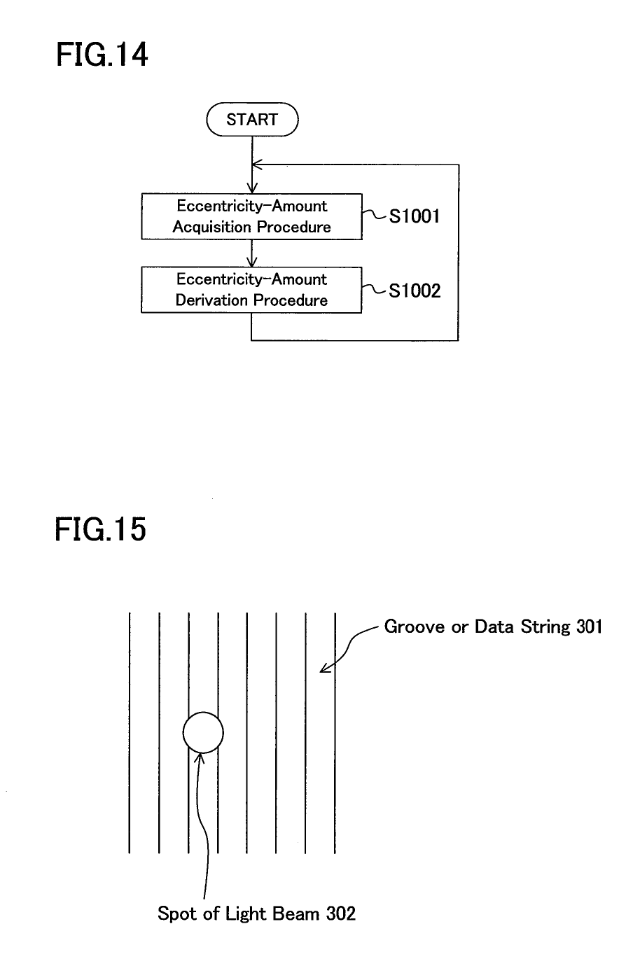

First, the optical disk 500 is placed on the optical disk data reproducing and recording device, and starts to rotate. Then, when the optical disk data reproducing and recording device changes to a focus-control ON state and changes to a tracking-control ON state, the operations shown in FIG. 14 are performed. FIG. 15 is an illustration showing a groove 301 of the optical disk and a spot 302 of the light beam when the optical disk data reproducing and recording device is in a focus-control ON state and in a tracking-control ON state. The operations shown in FIG. 14 will now be described.

(S1001) The eccentricity-amount acquisition section 206 acquires a low-frequency component of the tracking error signal.

(S1002) The eccentricity-amount derivation section 207 obtains a velocity of eccentricity based on the low-frequency component of the tracking error signal acquired by the eccentricity-amount acquisition section 206.

The operations at (S1001) and (S1002) are performed repeatedly.

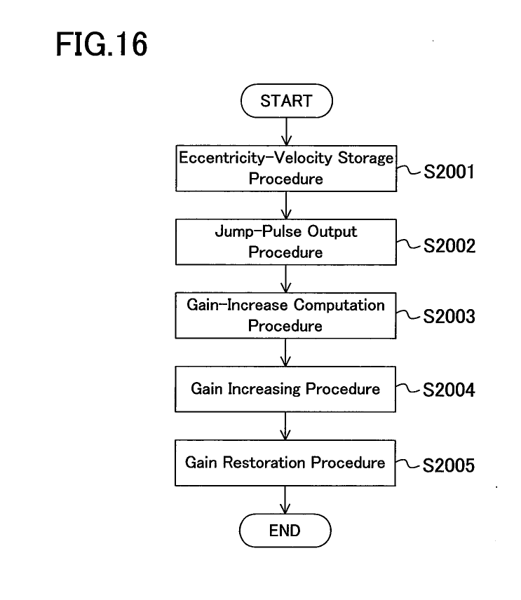

Next, a track jump is performed according to an instruction from the system controller 300. In more detail, when the tracking-control switching section 203 receives a track-jump command signal from the system controller 300, and outputs an eccentricity-velocity storage command signal to the eccentricity-velocity storage section 208, the operations shown in FIG. 16 are performed.

(S2001) The eccentricity-velocity storage section 208 stores, in the memory, the velocity of eccentricity E₁′(t), which is output by the eccentricity-amount derivation section 207 immediately before receiving the eccentricity-velocity storage command signal.

(S2002) The tracking-control switching section 203 stops the transmission of the tracking control signal from the tracking control section 202 to the tracking drive section 205. Thereafter, the jump-pulse output section 204 receives a jump-pulse output command signal from the tracking-control switching section 203, and outputs to the tracking drive section 205 a track-jump control signal representing the amount of movement of the optical pickup for a track jump. Then, the tracking drive section 205 receives this track-jump control signal, and outputs a drive signal to move the position of the converging lens 103 in a radial direction of the optical disk 500, to the tracking drive circuit 104 of the optical pickup 100. Accordingly, the converging lens 103 of the optical pickup 100 moves, and the irradiated point of the light beam moves in a radial direction of the optical disk 500. In this way, the optical disk signal processing unit 200 moves the converging lens 103 of the optical pickup 100 in a radial direction of the optical disk 500 by means of the drive signal obtained from the track-jump control signal (a track jump operation).

(S2003) The gain-increase computation section 209 obtains a corrective gain which indicates how many times the loop gain of the tracking control system after the track jump is made as large as the loop gain of the tracking control system before the track jump operation.

(S2004) After the jump-pulse output section 204 outputs the track-jump control signal to the tracking drive section 205, the tracking-control switching section 203 ceases the stop of transmission of a tracking control signal from the tracking control section 202 to the tracking drive section 205, and restarts the transmission. In addition, the loop gain of the tracking control system changes to a value which is the loop gain of the tracking control system before the track jump operation multiplied by a corrective gain obtained by the gain-increase computation section 209. In more detail, the gain of the loop-gain adjustment section 202f of the tracking control section 202 is multiplied by the corrective gain.

(S2005) Using as a trigger a rising edge of a timing signal which is output by the gain-switchover-timing generation section 210, the loop gain of the tracking control system returns to the loop gain before the track jump operation.

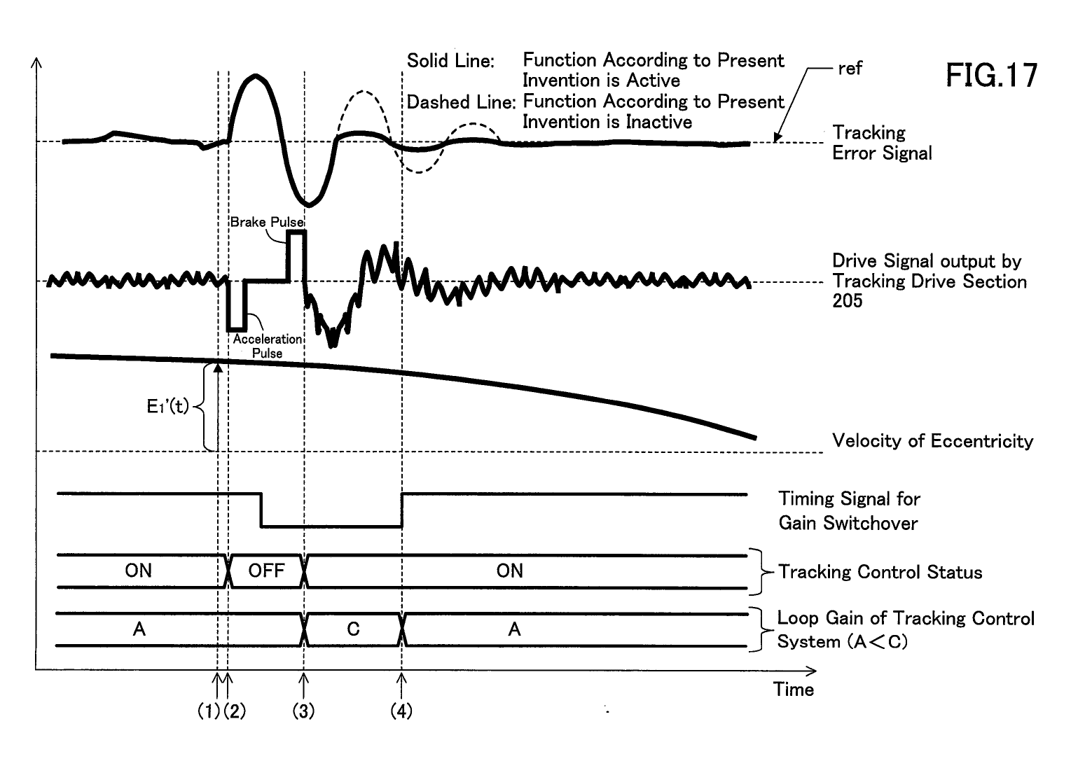

FIG. 17 is a graph illustrating waveforms of various signals when a track jump is executed, and a state of the optical disk data reproducing and recording device, etc.

In FIG. 17, at timing (1), the velocity of eccentricity E₁′(t) which is output by the eccentricity-amount derivation section 207 is stored in the memory. At timing (2), the tracking-control switching section 203 stops the transmission of the tracking control signal from the tracking control section 202 to the tracking drive section 205. Between timing (2) and timing (3), the tracking drive section 205 receives this track-jump control signal, and outputs a drive signal to move the converging lens 103 in a radial direction, to the tracking drive circuit 104 of the optical pickup 100. As shown in FIG. 17, an acceleration pulse and a brake pulse are output as drive signals to execute a track jump. At timing (3), the tracking-control switching section 203 ceases the stop of transmission of the tracking control signal from the tracking control section 202 to the tracking drive section 205, and restarts the transmission. Then, the tracking control section 202 starts outputting the track-jump control signal with a gain obtained by multiplication by the corrective gain. At timing (4), using as a trigger a rising edge of the timing signal which is output by the gain-switchover-timing generation section 210, the loop gain of the tracking control system returns to the loop gain before the track jump operation.

If the loop gain of the tracking control system is also maintained at A between timing (3) and timing (4), the tracking error signal will be like the one shown by a dashed line in FIG. 17. On the other hand, in this embodiment, by increasing the loop gain of the tracking control system to C between timing (3) and timing (4), the tracking error signal becomes such as shown by a solid line in FIG. 17, thus a settling time after the track jump is reduced.

In addition, as mentioned above, the time period during which the loop gain is maintained at a value obtained by multiplication by the corrective gain, that is, the time period between timing (3) and timing (4), is 200 μsec.

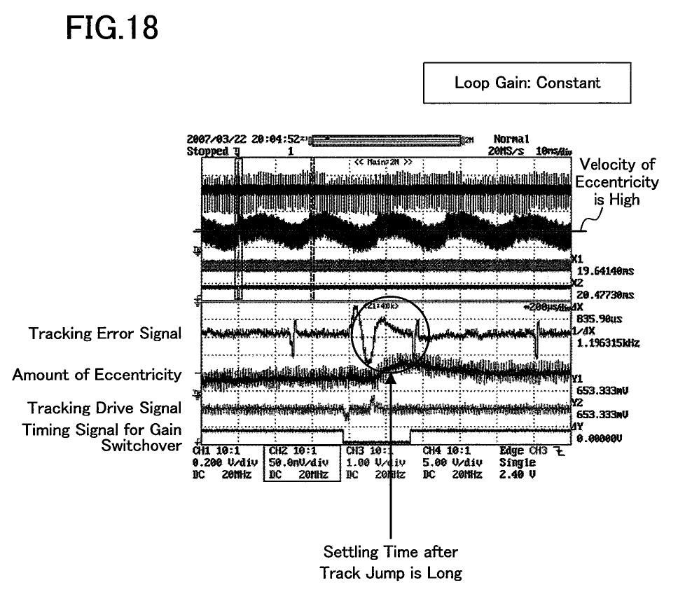

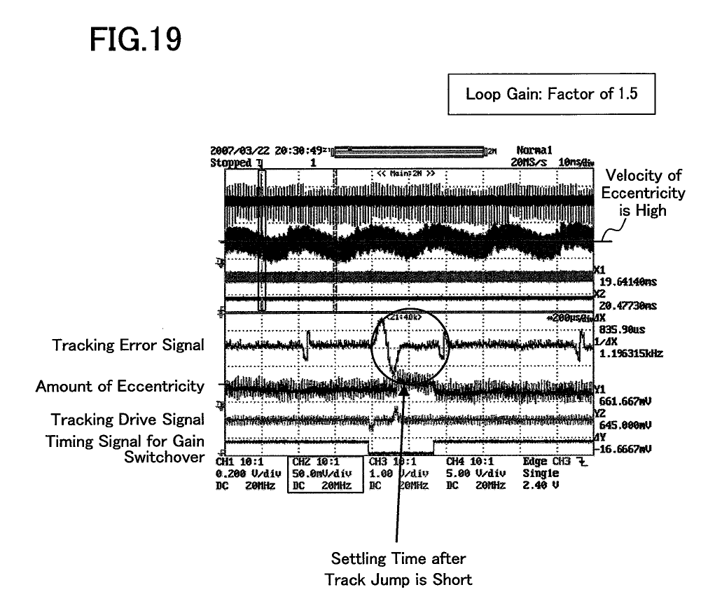

In FIG. 18, waveforms of various signals in a case where the loop gain of the tracking control system is constant are shown. Also, in FIG. 19, waveforms of various signals in a case where the loop gain is multiplied by 1.5 after a track-jump control signal is output by the jump-pulse output section 204.

In this way, it is possible to reduce the time until the tracking control settles down after the track jump by increasing the loop gain of the tracking control system included in the tracking control section 202 by an amount based on the velocity of eccentricity for a particular time period so that the time from when the jump-pulse output section 204 outputs the track-jump control signal until the tracking error detected by the tracking-error detection section 201 falls within a particular range will be reduced.

In the above embodiment, the eccentricity-amount acquisition section 206 has been described as acquiring an output of the adder 202d in the tracking control section 202. However, the eccentricity-amount acquisition section 206 may individually include an integral filter which receives the tracking error signal, an amplifier which receives the tracking error signal, and an adder which adds an output of the integral filter to an output of the amplifier, and may acquire an output of the adder as the low-frequency component of the tracking error signal.

In addition, the eccentricity-amount acquisition section 206 has been described as acquiring and outputting the low-frequency component of a tracking error signal as a signal representing an amount of eccentricity. However, the eccentricity-amount acquisition section 206 may extract the low-frequency component from a drive signal which is output by the tracking drive section 205, and output instead of the low-frequency component of the tracking error signal. Alternatively, it may average the drive signal and output the result. In addition, if the optical disk data reproducing and recording device includes a sensor which detects a misalignment of a lens (in a tracking direction), it may acquire a signal representing an amount of eccentricity based on a sensor value. In more detail, it may acquire the low-frequency component of the sensor value or an averaged value of the sensor value as a signal representing an amount of eccentricity.

Furthermore, although in the above embodiment, the velocity of eccentricity which is a temporal change rate of the amount of eccentricity has been described as being obtained by a process in which the amount of eccentricity is differentiated by the eccentricity-amount derivation section 207, another method of computation may be used.

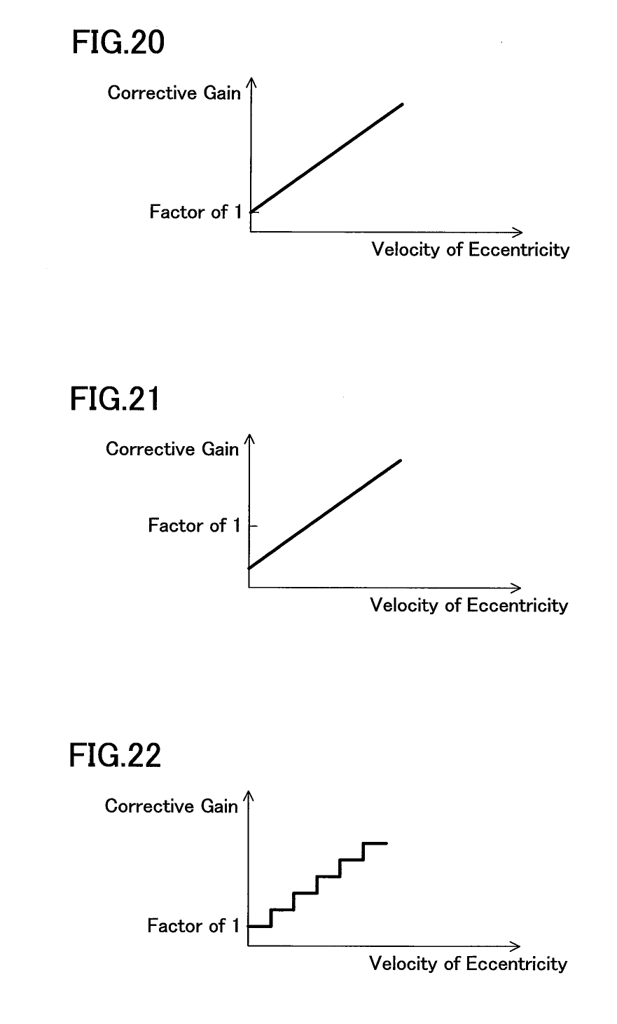

In addition, the gain-increase computation section 209 has been described as obtaining the corrective gain so that the corrective gain and the velocity of eccentricity will have a relationship as shown in FIG. 10. However, the corrective gain may be obtained so that the corrective gain and the velocity of eccentricity will have a relationship as shown in FIG. 20. That is, it may be configured so that, not after the velocity of eccentricity exceeds the threshold E₀′(t), but after the velocity of eccentricity exceeds 0, will increase the corrective gain in proportion to the increase in the velocity of eccentricity. Also, the gain-increase computation section 209 may output a corrective gain less than 1 when the velocity of eccentricity is low. For example, the corrective gain may be obtained so that the corrective gain and the velocity of eccentricity will have a relationship, for example, as shown in FIG. 21. Alternatively, the gain-increase computation section 209 may obtain the corrective gain so that the corrective gain will increase in a stepwise fashion according to an increase in the velocity of eccentricity as shown in FIG. 22. In the relationships between the corrective gain and the velocity of eccentricity shown in FIGS. 10, 12, 20, 21, and 22, a point that a corrective gain has a tendency to increase, that is, a point that a corrective gain rises according to an increase in the velocity of eccentricity is common.

Moreover, the gain-increase computation section 209 has been described as computing the corrective gain which indicates how many times the loop gain of the tracking control system after the track jump is made as large as the loop gain of the tracking control system before the track jump. However, not limited to a corrective gain, an absolute amount indicating how much to increase or decrease the loop gain of the tracking control system, or the loop gain itself may be computed and reflected in the tracking control.

Furthermore, in order that the particular time period during which the loop gain is maintained at a value obtained by multiplication by the corrective gain may be a time period corresponding to the reciprocal of the frequency in a case where a gain of an open-loop characteristic of the tracking control system is a predetermined gain other than 0 dB, a timing signal may be generated by the gain-switchover-timing generation section 210.

Alternatively, the particular time period during which the loop gain is maintained at a value obtained by multiplication by the corrective gain may be, not a time period corresponding to the reciprocal of the frequency x2 (1/x2) itself in a case where the gain of the open-loop characteristic of the tracking control system is a predetermined gain A, but a time period obtained by a predetermined operation (e.g., a proportional operation) using this time period. For example, the particular time period may be a time period which is obtained by multiplying, by a predetermined value, the reciprocal of the frequency in a case where the gain of the open-loop characteristic of the tracking control system is a predetermined gain. For example, assume that the time period during which the loop gain is maintained at a value obtained by multiplication by the corrective gain is a time period which is obtained by doubling the reciprocal of the frequency (2×1/x2) in a case where the gain of the open-loop characteristic of the tracking control system is 0 dB. In this case, under the condition of the above embodiment, the gain-switchover-timing generation section 210 is configured to generate a timing signal which rises 400 μsec after the completion of an output of the track-jump control signal by the jump-pulse output section 204.

Further alternatively, the particular time period during which the loop gain is maintained at a value obtained by multiplication by the corrective gain may be a time period corresponding to the reciprocal of the rotational frequency R (1/R) at the time of a jump, that is, when the track-jump control signal is output by the jump-pulse output section 204. For example, if the rotational frequency R at the time of a jump is 200 Hz, this time period is 1/200 Hz=5 msec. Still alternatively, the time period during which the loop gain is maintained at a value obtained by multiplication by the corrective gain may be a time period obtained by a predetermined operation (e.g., a proportional operation) using the time period corresponding to the reciprocal of the rotational frequency R (1/R) at the time of a jump. For example, assume that the particular time period during which the loop gain is maintained at a value obtained by multiplication by the corrective gain is a time period which is the reciprocal of a rotational frequency R at the time of a jump multiplied by 0.1 (0.1×1/R). In this case, if the rotational frequency R at the time of a jump is 200 Hz, this time period is 500 μsec.

In addition, the time period during which the loop gain is maintained at a value obtained by multiplication by the corrective gain may be a time period obtained by an operation using both of the time period corresponding to the reciprocal of the frequency x2 (1/x2) in a case where the gain of the open-loop characteristic of the tracking control system is a particular gain, and the time period corresponding to the reciprocal of the rotational frequency R (1/R) at the time of a jump. For example, the time period during which the loop gain is maintained at a value obtained by multiplication by the corrective gain may be an average of a time period obtained by doubling the reciprocal of the frequency x2 and a time period which is the reciprocal of the rotational frequency R at the time of a jump multiplied by 0.1. In this case, if the condition is the same as that of the above embodiment, and the rotational frequency R at the time of a jump is 200 Hz, then the time period during which the loop gain is maintained at a value obtained by multiplication by the corrective gain is (400 μsec+500 μsec)/2=450 μsec.

By multiplying, by a predetermined value, the reciprocal of the frequency of a disturbance in a case where the gain of the open-loop characteristic of the tracking control system is a predetermined gain, or by multiplying, by a predetermined value, the reciprocal of the rotational frequency at the time of a track jump operation, a suitable time period which is neither too long nor too short can be obtained as a particular time period during which the loop gain is maintained at a value obtained by multiplication by the corrective gain. If this particular time period is too long, the tracking control may become unstable after the tracking control settles down after a track jump, or the amount of power consumed from the completion of a track jump operation to a return of the loop gain to an original one may be large. Alternatively, if this particular time period is too short, the effect by multiplying the loop gain by the corrective gain after a track jump is not sufficiently achieved, and the settling time becomes long. Therefore, by using the frequency of a disturbance or the rotation frequency as mentioned above, a situation, in which tracking control becomes unstable after the tracking control settles down after a track jump, is prevented by suitably obtaining the time period during which the loop gain is maintained at a value obtained by multiplication by the corrective gain, and the amount of power consumed from the completion of a track jump operation to a return of the loop gain to the original one can be reduced.

Note that, in an optical disk data reproducing and recording device in which the rotation speed of the optical disk changes among a plurality of kinds, the time periods during which the loop gain is maintained at a value obtained by multiplication by the corrective gain may be recorded for each rotation speed, and may be maintained at the value which is the loop gain obtained by multiplication by the corrective gain for a time period, which is stored in association with the rotation speed at the time of the track jump operation, after the track jump operation.

### INDUSTRIAL APPLICABILITY

Optical disk signal processing units, optical disk data reproducing and recording devices, and optical disk signal processing methods in accordance with the present invention have an advantage that an access time of an optical disk device can be reduced, and an advantage that the cost of an optical disk device can be reduced, and, for example, are useful as optical disk devices and optical disk signal processing methods, etc. which perform tracking control.

### DESCRIPTION OF REFERENCE CHARACTERS

100 Optical Pickup
101 Light Source
102 Semi-Transparent Mirror
103 Converging Lens
104 Tracking Drive Circuit
105 Split Photodetector
200 Optical Disk Signal Processing Unit
201 Tracking-Error Detection Section
202 Tracking Control Section
202a Integral Filter
202b Amplifier
202c Differential Filter
202d Adder
202e Adder
202f Loop-Gain Adjustment Section
203 Tracking-Control Switching Section
204 Jump-Pulse Output Section
205 Tracking Drive Section
206 Eccentricity-Amount Acquisition Section
207 Eccentricity-Amount Derivation Section (Eccentricity-Velocity Computation Section)
207a Differential Filter
207b Attenuator
208 Eccentricity-Velocity Storage Section
209 Gain-Increase Computation Section (Gain-Change Computation Section)
210 Gain-Switchover-Timing Generation Section
300 System Controller
301 Groove
302 Spot
400 Rotational Part
500 Optical Disk

1. An optical disk signal processing unit which performs, in an optical disk device, tracking control to control a position of an optical pickup based on a tracking error signal, and a track jump operation to move the optical pickup in a radial direction of an optical disk while the tracking control is stopped, the optical disk signal processing unit comprising:
a gain-change computation section configured to obtain an amount of change of a loop gain of a tracking control system based on a velocity of eccentricity of the optical disk at the time of the track jump operation,
wherein
the tracking control is performed after the track jump operation in a situation where the loop gain of the tracking control system has been changed by the amount of change obtained by the gain-change computation section.

2. The optical disk signal processing unit of claim 1, further comprising:
an eccentricity-amount acquisition section configured to acquire a variation in a distance from a center point of a rotation of the optical disk to an irradiated point of a light beam as a change in an amount of eccentricity of the optical disk; and
an eccentricity-velocity computation section configured to compute the velocity of eccentricity of the optical disk based on the change in the amount of eccentricity acquired by the eccentricity-amount acquisition section,
wherein
the gain-change computation section obtains the amount of change of the loop gain based on the velocity of eccentricity of the optical disk at the time of the track jump operation which is computed by the eccentricity-velocity computation section.

3. The optical disk signal processing unit of claim 2, further comprising:
an eccentricity-velocity storage section configured to store the velocity of eccentricity computed by the eccentricity-velocity computation section immediately before the track jump operation,
wherein
the gain-change computation section obtains the amount of change of the loop gain based on the velocity of eccentricity stored by the eccentricity-velocity storage section.

4. The optical disk signal processing unit of claim 2, wherein
the eccentricity-amount acquisition section acquires a variation in a low-frequency component of the tracking error signal as the change in the amount of eccentricity.

5. The optical disk signal processing unit of claim 2, wherein
the eccentricity-velocity computation section computes the velocity of eccentricity by differentiating the change in the amount of eccentricity acquired by the eccentricity-amount acquisition section.

6. The optical disk signal processing unit of claim 1, wherein
the amount of change of the loop gain obtained by the gain-change computation section is an amount of increase of the loop gain, and increases depending on an increase of the velocity of eccentricity.

7. The optical disk signal processing unit of claim 6, wherein
the amount of increase of the loop gain obtained by the gain-change computation section is zero when the velocity of eccentricity is less than or equal to a predetermined threshold, and increases in proportion to the increase of the velocity of eccentricity when the velocity of eccentricity is greater than the predetermined threshold.

8. The optical disk signal processing unit of claim 1, wherein
the tracking control is performed while the loop gain of the tracking control system has been changed by the amount of change obtained by the gain-change computation section for a particular time period after the track jump operation.

9. An optical disk signal processing unit which performs, in an optical disk device, tracking control to control a position of an optical pickup based on a tracking error signal, and a track jump operation to move the optical pickup in a radial direction of an optical disk while the tracking control is stopped, wherein
the tracking control is performed in a situation where the loop gain of the tracking control system is increased from the loop gain before the track jump operation for a particular time period after the track jump operation, and after the particular time period has elapsed, the loop gain of the tracking control system is returned to the loop gain before the track jump operation.

10. The optical disk signal processing unit of claim 9, wherein
the particular time period is a time period which is obtained by multiplying, by a predetermined value, the reciprocal of a frequency of a disturbance in a case where the gain of the open-loop characteristic of the tracking control system is a predetermined value.

11. The optical disk signal processing unit of claim 9, wherein
the particular time period is a time period which is obtained by multiplying, by a predetermined value, the reciprocal of a rotational frequency at the time of a track jump operation.

12. An optical disk data reproducing and recording device, comprising:
the optical disk signal processing unit of any one of claims 1 to 11;
the optical pickup; and
a rotation part configured to rotate the optical disk.

13. An optical disk signal processing method by an optical disk signal processing unit which performs, in an optical disk device, tracking control to control a position of an optical pickup based on a tracking error signal, and a track jump operation to move the optical pickup in a radial direction of an optical disk while the tracking control is stopped, the optical disk signal processing method comprising:
a gain-change computation step of obtaining an amount of change of a loop gain of a tracking control system based on a velocity of eccentricity of the optical disk at the time of the track jump operation,
wherein
the tracking control is performed after the track jump operation in a situation where the loop gain of the tracking control system has been changed by the amount of change obtained in the gain-change computation step.

14. The optical disk signal processing method of claim 13, further comprising:
an eccentricity-amount acquisition step of acquiring a variation in a distance from a center point of a rotation of the optical disk to an irradiated point of a light beam as a change in an amount of eccentricity of the optical disk; and
an eccentricity-velocity computation step of computing the velocity of eccentricity of the optical disk based on the change in the amount of eccentricity acquired in the eccentricity-amount acquisition step,
wherein
the gain-change computation step obtains the amount of change of the loop gain based on the velocity of eccentricity of the optical disk at the time of the track jump operation which is computed in the eccentricity-velocity computation step.

15. The optical disk signal processing method of claim 14, further comprising:
an eccentricity-velocity storage step of storing the velocity of eccentricity computed in the eccentricity-velocity computation step immediately before the track jump operation, wherein the gain-change computation step obtains the amount of change of the loop gain based on the velocity of eccentricity stored in the eccentricity-velocity storage step.

16. The optical disk signal processing method of claim 14, wherein
the eccentricity-amount acquisition step acquires a variation in a low-frequency component of the tracking error signal as the change in the amount of eccentricity.

17. The optical disk signal processing method of claim 14, wherein
the eccentricity-velocity computation step computes the velocity of eccentricity by differentiating the change in the amount of eccentricity acquired in the eccentricity-amount acquisition step.

18. The optical disk signal processing method of claim 13, wherein
the amount of change of the loop gain obtained in the gain-change computation step is an amount of increase of the loop gain, and increases depending on an increase of the velocity of eccentricity.

19. The optical disk signal processing method of claim 18, wherein
the amount of increase of the loop gain obtained in the gain-change computation step is zero when the velocity of eccentricity is less than or equal to a predetermined threshold, and increases in proportion to the increase of the velocity of eccentricity when the velocity of eccentricity is greater than the predetermined threshold.

20. The optical disk signal processing method of claim 13, wherein
the tracking control is performed while the loop gain of the tracking control system has been changed by the amount of change obtained in the gain-change computation step for a particular time period after the track jump operation.

21. An optical disk signal processing method by an optical disk signal processing unit which performs, in an optical disk device, tracking control to control a position of an optical pickup based on a tracking error signal, and a track jump operation to move the optical pickup in a radial direction of an optical disk while the tracking control is stopped, wherein
the tracking control is performed in a situation where the loop gain of the tracking control system is changed from the loop gain before the track jump operation for a particular time period after the track jump operation, and after the particular time period has elapsed, the loop gain of the tracking control system is returned to the loop gain before the track jump operation.

22. The optical disk signal processing method of claim 21, wherein
the particular time period is a time period which is obtained by multiplying, by a predetermined value, the reciprocal of a frequency in a case where the gain of the open-loop characteristic of the tracking control system is a predetermined value.

23. The optical disk signal processing method of claim 21, wherein
the particular time period is a time period which is obtained by multiplying, by a predetermined value, the reciprocal of a rotational frequency at the time of a track jump operation.
